(19) United States
(12) Patent Application Publication
(10) Pub. No.: US 2025/0201109 A1
(43) Pub. Date: Jun. 19, 2025

(54) REMOTE CONTROLLER

(71) Applicant: Mitsubishi Electric Corporation, Tokyo (JP)

(72) Inventor: Takuma AOSHIMA, Tokyo (JP)

(21) Appl. No.: 18/832,161

(22) PCT Filed: Apr. 18, 2022
(86) PCT No.: PCT/JP2022/018014

§ 371 Date: Jul. 23, 2024

(51) Int. Cl. G08C 23/04

(52) U.S. Cl. CPC G08C 23/04

(57) ABSTRACT

A remote that refers to a remote controller includes a lithium-ion battery; an infrared signal transmission unit and a resistor that are connected in parallel with the lithium-ion battery, with the resistor being a first resistor connected in series with the infrared signal transmission unit; a micro as a microcomputer that controls transmission of an infrared signal from the infrared signal transmission unit and is connected in parallel with the lithium-ion battery; and a plurality of capacitors that are connected in parallel with the micro and include at least two ceramic capacitors.

### FIELD

The present disclosure relates to a remote controller using a lithium-ion battery.

### BACKGROUND

When operating an apparatus such as an air conditioner, users have used an attached remote controller (hereinafter referred to as the remote) or another device to set a desired temperature and others. In the remote, an input unit such as keys receives a user input, and in response to the user input, a control unit such as a microcomputer (hereinafter referred to as the micro) causes an infrared light emitting diode (LED) to emit light for transmitting an infrared signal to the apparatus, such the air conditioner, thus controlling the operation of the apparatus like the air conditioner. Some remotes internally include electrolytic capacitors for power supply stabilization in order to stabilize internal power supply voltage supplied for micros from batteries. Patent Literature 1, for example, discloses a technique that restrains generation of heat from a short circuit current in a remote even if an electrolytic capacitor for power supply stabilization is short-circuited.

### CITATION LIST

### Patent Literature

Patent Literature 1: Japanese Patent Application Laid-open No. 2000-316193

### SUMMARY OF INVENTION

### Problem to be Solved by the Invention

A lithium-ion battery finds use as a battery in the remote. The lithium-ion battery experiences increasing internal resistance due to aging degradation caused by an air environment. A circuit of the remote using the lithium-ion battery is such that a current-limiting resistor and a transistor or the like are connected in series with the infrared LED. The control unit, such as the micro, regulates current flow to the infrared LED by performing on-off control of the transistor, thus controlling the infrared signal transmission. The micro is typically mounted with a bypass capacitor of about 0.1 μF, as recommended for an integrated circuit (IC) or the like that is used as the micro, and an electrolytic capacitor of about 10 μF to 47 μF or the like, as needed for power supply stabilization, with these capacitors being in parallel with the lithium-ion battery. In a small remote using a lithium-ion battery, limited mounting space and a cost consideration are some reasons why unnecessary capacitors and higher-capacitance capacitors are not typically mounted.

When the remote with such a configuration is driven by the lithium-ion battery with increased internal resistance, the current that flows to the infrared LED flows to the internal resistance of the lithium-ion battery as well, thus leading to a decrease in the power supply voltage that is supplied from the lithium-ion battery, that is to say, the internal power supply voltage of the remote. Therefore, a problem with the remote is that when the internal power supply voltage goes below a reset voltage of the micro, the micro is reset, resulting in the infrared signal no longer being transmitted.

The present disclosure has been made in view of the above, and an object of the present disclosure is to obtain a remote controller capable of preventing interruption of infrared signal transmission even when a lithium-ion battery has increased internal resistance.

### Means to Solve the Problem

In order to solve the above problems and to achieve the object, a remote controller according to the present disclosure includes: a lithium-ion battery; an infrared signal transmission unit and a first resistor that are connected in parallel with the lithium-ion battery, the first resistor being connected in series with the infrared signal transmission unit; a microcomputer to control transmission of an infrared signal from the infrared signal transmission unit, the microcomputer being connected in parallel with the lithium-ion battery; and a plurality of capacitors connected in parallel with the microcomputer and including at least two ceramic capacitors.

### Effects of the Invention

The remote controller according to the present disclosure has an effect of preventing interruption of the infrared signal transmission even when the lithium-ion battery has increased internal resistance.

### BRIEF DESCRIPTION OF DRAWINGS

FIG. 1 is a diagram illustrating an exemplary configuration of a remote controller according to a first embodiment.

FIG. 2 is a diagram illustrating an exemplary configuration of a remote controller according to a second embodiment.

FIG. 3 is a diagram illustrating an example of a data frame of an infrared signal to be transmitted from an infrared signal transmission unit of the remote controller according to the second embodiment.

### DESCRIPTION OF EMBODIMENTS

With reference to the drawings, a detailed description is hereinafter provided of remote controllers according to embodiments of the present disclosure.

### First Embodiment

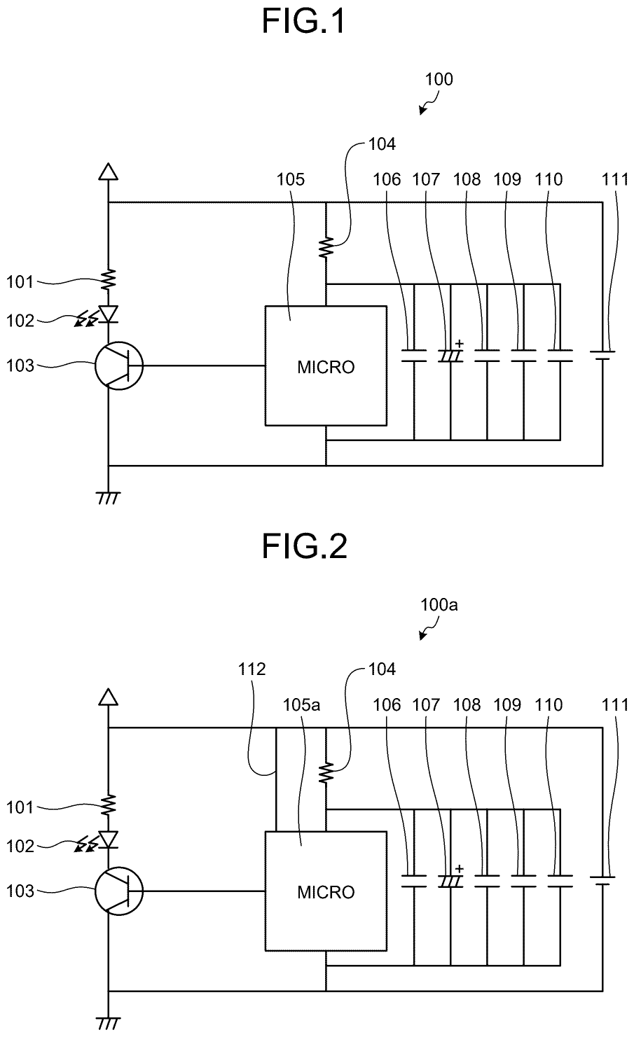

FIG. 1 is a diagram illustrating an exemplary configuration of a remote controller 100 according to a first embodiment. The remote controller 100 includes a resistor 101, an infrared signal transmission unit 102, a transistor 103, a resistor 104, a microcomputer 105, capacitors 106 to 110, and a lithium-ion battery 111. The remote 100 is a remote controller that is used to operate an apparatus such as an air conditioner (not illustrated).

The resistor 101 is a current-limiting resistor connected in series with the infrared signal transmission unit 102. In the following description, the resistor 101 may be referred to as the first resistor.

The infrared signal transmission unit 102 transmits infrared signals under control of the micro 105. The infrared signal transmission unit 102 is, for example, an infrared LED and emits infrared light when conductively driven by the transistor 103, thus transmitting an infrared signal.

The transistor 103 is connected in series with the infrared signal transmission unit 102 and turns on and off under the control of the micro 105 to regulate the conduction of the infrared signal transmission unit 102. The resistor 101, the infrared signal transmission unit 102, and the transistor 103 are connected in parallel with the lithium-ion battery 111.

The resistor 104 is a current-limiting resistor connected in series with the micro 105. The resistor 104 is connected between the lithium-ion battery 111 and the micro 105 and the capacitors 106 to 110. In the following description, the resistor 104 may be referred to as the second resistor.

The micro 105 is a microcomputer that controls the transmission of infrared signals from the infrared signal transmission unit 102. Specifically, the micro 105 receives a user input from an input unit (not illustrated) and performs the on-off control of the transistor 103 to transmit an infrared signal corresponding to user input content. The resistor 104 and the micro 105 are connected in parallel with the lithium-ion battery 111.

The capacitor 106 is connected between a power supply and a ground (hereinafter referred to as the GND) for the micro 105 and is a bypass capacitor with a capacitance of about 0.1 μF, as recommended for an IC or the like used as the micro 105. The capacitor 106 is, for example, a ceramic capacitor.

The capacitor 107 is connected between the power supply and the GND for the micro 105 and is an electrolytic capacitor for power supply stabilization, having a capacitance of about 10 μF to 47 μF for the power supply stabilization within the remote 100.

The capacitors 108 to 110 are connected between the power supply and the GND for the micro 105 and are higher-capacitance ceramic capacitors that maintain an internal power supply voltage of the remote 100 until the infrared signal transmission from the remote 100 is completed. While the remote 100 in the example of FIG. 1 has the capacitors 108 to 110, namely the three ceramic capacitors, this is not limiting. The number of ceramic capacitors of the remote 100, depending on required capacitance, as described later, may be two or fewer or four or more. Given the capacitor 106, the ceramic capacitors that the remote 100 has are to be at least two in number. In other words, the remote 100 has the plural capacitors, including the at least two ceramic capacitors, as the capacitors 106 to 110, which are connected in parallel with the micro 105.

The lithium-ion battery 111 is a battery that supplies the power supply voltage to the internal components of the remote 100. As mentioned earlier, the lithium-ion battery 111 characteristically experiences increasing internal resistance due to aging degradation caused by an air environment.

A combined capacitance of the capacitors 106 to 110, for which a calculation method is described later, needs to be 200 μF or more. Generally, the remote 100 using the lithium-ion battery 111 is often small and often lacks spare space for component mounting. Therefore, the remote 100 uses high-capacitance ceramic capacitors introduced in a lineup in recent years as the higher-capacitance capacitors 108 to 110 that maintain the internal power supply voltage of the remote 100. When it comes to the ceramic capacitors used as the capacitors 108 to 110, ceramic capacitors that each have a capacitance of 220 μF are currently the largest class in terms of a balance of costs and size. Therefore, using two to three 220 μF ceramic capacitors, depending on the required capacitance, in the configuration of the remote 100 is effective in resolving the problem, that is to say, maintaining the internal power supply voltage of the remote 100.

In the remote 100, current is supplied from the capacitors 108 to 110, which are the higher-capacitance ceramic capacitors, to the infrared signal transmission unit 102. However, there is a concern that too much current may flow from the capacitors 108 to 110 to the infrared signal transmission unit 102. If too much current flows to the infrared signal transmission unit 102, the infrared signal transmission unit 102 cannot transmit an infrared signal over a long period. Therefore, the remote 100 according to the present embodiment includes the current-limiting resistor 104 connected in series on a power supply side of the micro 105, enabling electric charge to be maintained while the infrared signal transmission unit 102 transmits the infrared signal.

With an adjusted balance of the capacitance of the capacitors 108 to 110, which are the ceramic capacitors, and a resistance value of the resistor 104, the remote 100 is enabled to maintain the power supply voltage while the infrared signal transmission unit 102 transmits the infrared signal. Since the resistor 104 is disposed in series between the lithium-ion battery 111 and the micro 105, the voltage that is supplied to the micro 105 may decrease when the current flows to the micro 105. Therefore, a resistor with too large a resistance value is typically not selected as the resistor 104. When it comes to the resistance value of the resistor 104, an empirically selected resistance value is about 10Ω; however, in the present embodiment, depending on balance with the combined capacitance of the capacitors 106 to 110, a resistance value of 20Ω or more is desirably selected to prevent the capacitance of the capacitors 106 to 110 from being too high.

A detailed description is provided of constants of circuit elements of the remote 100. The voltage that is supplied to the micro 105 when the current flows to the infrared signal transmission unit 102 in the remote 100 is determined by a resistance value of the resistor 101, the resistance value of the resistor 104, the combined capacitance of the capacitors 106 to 110, and an internal resistance value of the lithium-ion battery 111. The resistor 101 selected is to have a resistance value ensuring that transmission distance of an infrared signal from the infrared signal transmission unit 102 meets a requirement and satisfies a maximum rating of the lithium-ion battery 111 when the lithium-ion battery 111 used is in a normal, non-degraded state, that is to say, has no increased internal resistance. The constants of the capacitors 106 to 110, the resistor 101, and the resistor 104 that are used in the remote 100 meet a requirement defined by Formula (1) below.

C>−t/(R×ln(V1/V0)) (1)

In Formula (1), C represents the combined capacitance of the capacitors 106 to 110. R represents a combined resistance of the resistors 101 and 104. V0 represents a reset voltage of the micro 105. V1 represents the power supply voltage supplied from the lithium-ion battery 111. t represents total time during which the infrared signal is actually transmitted from the remote 100, namely the infrared signal transmission unit 102. t can also be said to be total time during which the infrared signal transmission unit 102 is conductively driven by the transistor 103.

Assume, for example, that the internal resistance value of the lithium-ion battery 111 has increased to about 300Ω. The current supply from the lithium-ion battery 111 is less than 1/10 compared to when the internal resistance value of the lithium-ion battery 111 is small and therefore can be approximated almost by Formula (1). When calculated using Formula (1), the combined capacitance of the capacitors 106 to 110 is practically 200 μF or more, the resistance value of the resistor 101 is about 10 to 20Ω, and the resistance value of the resistor 104 is 20Ω or more. By using the capacitors 106 to 110 and the resistors 101 and 104 that have the above constants, the remote 100 enables the transmission of the infrared signal from the infrared signal transmission unit 102 to continue even when there is an increase in the internal resistance of the lithium-ion battery 111. The above constants are also experimentally effective, enabling the remote 100 to prevent the internal power supply voltage of the remote 100 from becoming the reset voltage of the micro 105 until the infrared signal transmission unit 102 completes transmitting the infrared signal.

As described above, the remote 100 according to the present embodiment is equipped with, between the power supply and the GND for the micro 105, the capacitors 108 to 110, which are the higher-capacitance ceramic capacitors not commonly mounted in a small remote due to space constraint. Furthermore, the remote 100 uses the capacitors 106 to 110 and the resistors 101 and 104 that have the adjusted constants to prevent the internal power supply voltage of the remote 100 from becoming the reset voltage of the micro 105 or lower, even when the internal resistance value of the lithium-ion battery 111 increases. Therefore, even when the internal resistance value of the lithium-ion battery 111 increases, the micro 105 is prevented from being reset, enabling the remote 100 to prevent interruption of the infrared signal transmission and continue transmitting the infrared signal.

### Second Embodiment

In a second embodiment, a description is provided of a case where a microcomputer is equipped with a voltage monitoring port.

FIG. 2 is a diagram illustrating an exemplary configuration of a remote controller 100a according to the second embodiment. The remote 100a includes the microcomputer 105a in place of the micro 105 compared to the remote 100 illustrated in FIG. 1. The micro 105a includes the voltage monitoring port 112. The voltage monitoring port 112 utilizes an analog to digital (AD) conversion function of the micro 105a and monitors power supply voltage supplied from the lithium-ion battery 111, as illustrated in FIG. 2.

When the lithium-ion battery 111 has an increased internal resistance value, current flow to the infrared signal transmission unit 102 involves a faster voltage drop across the lithium-ion battery 111 in the remote 100a. This is calculated using Formula (2) below.

V=Vb−Iled1×Rb (2)

In Formula (2), V represents the voltage monitored or detected by the voltage monitoring port 112. Vb represents the power supply voltage supplied from the lithium-ion battery 111. Iled1 represents current flowing to the infrared signal transmission unit 102. Rb represents the internal resistance value of the lithium-ion battery 111.

By using Formula (2), the micro 105a can ascertain a difference between the voltage monitored by the voltage monitoring port 112 during the current flow to the infrared signal transmission unit 102 and the voltage monitored by the voltage monitoring port 112 in the absence of the current flow to the infrared signal transmission unit 102. When the difference is greater than or equal to a specified threshold, the micro 105a can detect that the internal resistance value of the lithium-ion battery 111 has increased. Therefore, upon detecting the increased internal resistance value of the lithium-ion battery 111 as a result of the monitoring by the voltage monitoring port 112 in transmission of an infrared signal from the infrared signal transmission unit 102, the micro 105a adjusts length of the infrared signal to be transmitted from the infrared signal transmission unit 102.

In other words, the micro 105a detects the internal resistance value of the lithium-ion battery 111 on the basis of a variation that the voltage monitoring port 112 detects in the power supply voltage supplied from the lithium-ion battery 111. Depending on the detected resistance value, the micro 105a adjusts a transmission pattern of the infrared signal to be transmitted from the infrared signal transmission unit 102. The micro 105a may detect the internal resistance value of the lithium-ion battery 111 not only when a user input-based infrared signal is transmitted from the infrared signal transmission unit 102 but also when an infrared signal is transmitted from the infrared signal transmission unit 102 in a trial manner before a user input-based infrared signal is transmitted from the infrared signal transmission unit 102.

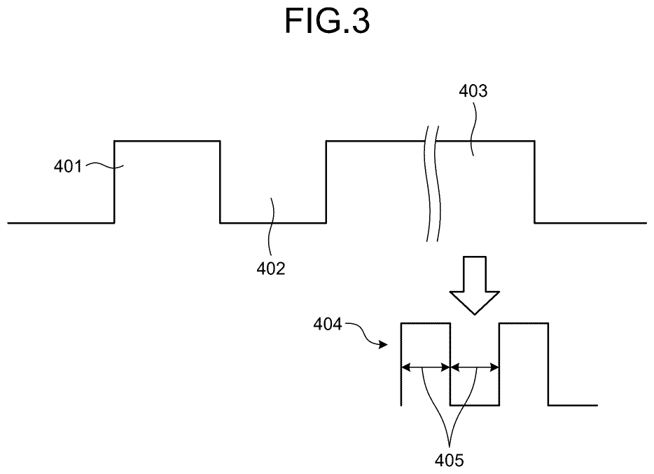

FIG. 3 is a diagram illustrating an example of a data frame of an infrared signal to be transmitted from the infrared signal transmission unit 102 of the remote 100a according to the second embodiment. On an upper side of FIG. 3, a diagram of the data frame of an infrared signal to be transmitted from the infrared signal transmission unit 102 is illustrated, illustrating a dummy frame 401, a transmission prohibition interval 402, and a main frame 403. A diagram on a lower side of FIG. 3 illustrates actual data bits 404 within the main frame 403 and bit length 405 per bit. As illustrated in FIG. 3, when transmitting the infrared signal from the infrared signal transmission unit 102, the remote 100a, depending on a model, once transmits the dummy frame 401 for a specified time to stabilize reception performance of a light-receiving element of an apparatus that receives the infrared signal and following the transmission prohibition interval 402, transmits the main frame 403, which includes actual transmission data.

By stabilizing the reception performance of the light-receiving element of the apparatus that receives the infrared signal through the transmission of the dummy frame 401, the remote 100a enables an extended transmission distance for the infrared signal, specifically for the main frame 403. On the other hand, the power supply voltage's dropping to the reset voltage of the micro 105a or lower when supplied to the micro 105a due to an increased internal resistance value of the lithium-ion battery 111 may cause the remote 100a to interrupt the infrared signal transmission at a midway point. In such a case, the remote 100a needs to give priority to bringing the infrared signal transmission to completion over extending the transmission distance for the infrared signal. Accordingly, the remote 100a does not transmit the dummy frame 401. In this way, the remote 100a can reduce conduction time of the infrared signal transmission unit 102. Since time for electric supply from the lithium-ion battery 111 to the capacitors 106 to 110 also increases, the remote 100a is capable of preventing the power supply voltage from becoming the reset voltage or lower when supplied to the micro 105a. In this case, on the basis of the detected internal resistance value of the lithium-ion battery 111, the micro 105a determines whether or not to transmit the dummy frame 401 in the transmission pattern of the infrared signal to be transmitted from the infrared signal transmission unit 102.

As illustrated in FIG. 3, the data bits 404 are included in the main frame 403, and by standards, there is a specified range for the bit length 405 of each of the data bits 404. Normally, the remote 100a often transmits an infrared signal with the bit length 405 set at a median value of the specified range for stabilizing the reception performance of the light-receiving element of the apparatus that receives the infrared signal. In the present embodiment, the remote 100a changes the on-time bit length 405 to a value closer to a lower limit of the specified range when transmitting the infrared signal and further changes the off-time bit length 405 to a value closer to an upper limit of the specified range, thus enabling reduced overall on time and increased overall off time when transmitting the main frame 403. The on time is a period during which the data bit 404 in FIG. 3 represents a HIGH state where there is actual infrared light emission from the infrared signal transmission unit 102. The off time is a period during which the data bit 404 in FIG. 3 represents a LOW state where there is no infrared light emission from the infrared signal transmission unit 102. In this way, the remote 100a can reduce the conduction time of the infrared signal transmission unit 102. Since the time for the electric supply from the lithium-ion battery 111 to the capacitors 106 to 110 also increases, the remote 100a can prevent the power supply voltage from becoming the reset voltage or lower when supplied to the micro 105a.

As described above, the micro 105a monitors the voltage by use of the voltage monitoring port 112 and performs the operations, such as not transmitting the dummy frame 401 and changing the bit lengths 405 of the on-time and off-time data bits 404, to enable a further reduction in capacitance of the capacitors 106 to 110. Therefore, the remote 100a allows for reduced costs of the capacitors 106 to 110, in addition to preventing the micro 105a from being reset. For the transmission pattern of the infrared signal to be transmitted from the infrared signal transmission unit 102, depending on the detected internal resistance value of the lithium-ion battery 111, the micro 105a here reduces the bit length 405 of the on-time data bit 404 of the transmission data, increases the bit length 405 of the off-time data bit 404 of the transmission data, or both reduces the bit length 405 of the on-time data bit 404 of the transmission data and increases the bit length 405 of the off-time data bit 404 of the transmission data.

As described above, the micro 105a of the remote 100a according to the present embodiment is equipped with the voltage monitoring port 112. The micro 105a detects an internal resistance value of the lithium-ion battery 111 on the basis of a variation that the voltage monitoring port 112 detects in the power supply voltage supplied from the lithium-ion battery 111. Depending on the detected resistance value, the micro 105a adjusts the transmission pattern of an infrared signal to be transmitted from the infrared signal transmission unit 102. In this manner, the remote 100a enables a reduced time for the infrared signal transmission unit 102 to transmit the infrared signal through actual light emission, thus reducing current consumption within the remote 100a. Consequently, the remote 100a can be driven even with a lower power supply voltage and transmit infrared signals even at a lower remaining battery level of the lithium-ion battery 111, having an effect of extending battery life.

The above configurations illustrated in the embodiments are illustrative, can be combined with other techniques that are publicly known, and can be partly omitted or changed without departing from the gist. The embodiments can be combined with each other.

### REFERENCE SIGNS LIST

100, 100a remote controller; 101, 104 resistor; 102 infrared signal transmission unit; 103 transistor; 105, 105a microcomputer; 106 capacitor (bypass capacitor); 107 capacitor (electrolytic capacitor for power supply stabilization); 108 to 110 capacitor (ceramic capacitor); 111 lithium-ion battery; 112 voltage monitoring port; 401 dummy frame; 402 transmission prohibition interval; 403 main frame; 404 data bit; 405 bit length.

1. A remote controller comprising:
a lithium-ion battery;
an infrared signal transmitter and a first resistor that are connected in parallel with the lithium-ion battery, the first resistor being connected in series with the infrared signal transmitter;
a microcomputer to control transmission of an infrared signal from the infrared signal transmitter, the microcomputer being connected in parallel with the lithium-ion battery;
a plurality of capacitors connected in parallel with the microcomputer and including at least two ceramic capacitors; and
a second resistor connected between the lithium-ion battery and the microcomputer and the plurality of capacitors, wherein
the plurality of capacitors have a combined capacitance of at least 200 μF, and the second resistor has a resistance value of at least 20Ω.

2. (canceled)

3. (canceled)

4. A remote controller comprising:
a lithium-ion battery;
an infrared signal transmitter and a first resistor that are connected in parallel with the lithium-ion battery, the first resistor being connected in series with the infrared signal transmitter;
a microcomputer to control transmission of an infrared signal from the infrared signal transmitter, the microcomputer being connected in parallel with the lithium-ion battery:
a plurality of capacitors connected in parallel with the microcomputer and including at least two ceramic capacitors; and
a second resistor connected between the lithium-ion battery and the microcomputer and the plurality of capacitors, wherein
the plurality of capacitors, the first resistor, and the second resistor that are used have constants meeting a requirement defined by the formula:
C>−t/(R×ln(V1/V0)), where
C represents a combined capacitance of the plurality of capacitors,
R represents a combined resistance of the first resistor and the second resistor,
V0 represents a reset voltage of the microcomputer,
V1 represents a power supply voltage supplied from the lithium-ion battery, and
t represents total time of the infrared signal transmission from the infrared signal transmitter.

5. A remote controller comprising:
a lithium-ion battery;
an infrared signal transmitter and a first resistor that are connected in parallel with the lithium-ion battery, the first resistor being connected in series with the infrared signal transmitter;
a microcomputer to control transmission of an infrared signal from the infrared signal transmitter, the microcomputer being connected in parallel with the lithium-ion battery; and
a plurality of capacitors connected in parallel with the microcomputer and including at least two ceramic capacitors, wherein
the microcomputer includes a voltage detection port, detects an internal resistance value of the lithium-ion battery on a basis of a variation that the voltage detection port detects in power supply voltage supplied from the lithium-ion battery, and adjusts a transmission pattern of the infrared signal to be transmitted from the infrared signal transmitter, depending on the resistance value detected.

6. The remote controller according to claim 5, wherein
the microcomputer detects the internal resistance value of the lithium-ion battery when or before the infrared signal based on a user input is transmitted from the infrared signal transmitter and determines whether or not to transmit a dummy frame in the transmission pattern of the infrared signal to be transmitted from the infrared signal transmitter on a basis of the resistance value detected.

7. The remote controller according to claim 5, wherein
the microcomputer detects the internal resistance value of the lithium-ion battery when or before the infrared signal based on a user input is transmitted from the infrared signal transmitter, and for the transmission pattern of the infrared signal to be transmitted from the infrared signal transmitter, depending on the resistance value detected, the microcomputer performs one of reducing a bit length of an on-time data bit of transmission data, increasing a bit length of an off-time data bit of the transmission data, and both reducing the bit length of the on-time data bit of the transmission data and increasing the bit length of the off-time data bit of the transmission data.
